(19) United States
(12) Patent Application Publication
(10) Pub. No.: US 2026/0367488 A1
(43) Pub. Date: Nov. 19, 2026

(54) WEARABLE QUICK-RELEASE CONNECTION STRUCTURE FOR PHOTOGRAPHY DEVICE

(71) Applicant: SHENZHEN LEQI INNOVATION CO., LTD., SHENZHEN (CN)

(72) Inventors: YAXIONG YAN, SHENZHEN (CN); ZHIQIANG PAN, SHENZHEN (CN)

(21) Appl. No.: 19/251,808

(22) Filed: Jun. 27, 2025

(30) Foreign Application Priority Data
May 16, 2025 (CN) 202520977231.1

(51) Int. Cl. G03B 17/56; A45F 5/00

(52) U.S. Cl. CPC G03B 17/561; A45F 5/1533; A45F 2005/006

(57) ABSTRACT

A wearable quick-release connection structure for a photography device is provided, which includes a male connector and a female connector. The male connector includes a plug component provided with a locking portion and a lanyard. The female connector includes a bearing seat and a locking assembly. The bearing seat is defined with a receiving cavity. The receiving cavity is featured with an access port configured to receive the plug component and a wire routing port. The plug component is capable of being inserted into the receiving cavity through the access port and advancing toward the wire routing port. The locking assembly is arranged in the bearing seat and at least partially located within the receiving cavity. The locking assembly includes at least one locking component capable of moving relative to the bearing seat, and the locking component is provided with a snap-fit portion engaged with the locking portion.

### TECHNICAL FIELD

The present disclosure relates to the technical field of photography auxiliary equipment, and in particular to a wearable quick-release connection structure for a photography device.

### BACKGROUND

In the field of photography, auxiliary devices, such as neck straps, shoulder straps, and wrist straps, serve as primary means for securing photography devices. The safety and convenience of their connection structures are very important. By safely and conveniently fastening cameras and other photography equipment to the user's body, these auxiliary devices not only free up both hands but also significantly reduce the risk of accidental drops of the cameras.

Currently, common connection methods between photography devices and wearable devices like neck straps or wrist straps on the market suffer from multiple shortcomings. Some quick-release wearable connection structures require specialized tools for installation and removal, therefore, this cumbersome process prevents rapid deployment in urgent shooting scenarios, severely limiting photographic efficiency. Others, while tool-free, demand continuous angular adjustments and precise force control during operation. Such designs not only cause inconvenience but also pose safety risks due to poor connection stability and susceptibility to unintentional detachment, failing to provide reliable and secure attachment for the photography devices.

### SUMMARY

The main objective of the present disclosure is to provide a wearable quick-release connection structure for a photography device, aiming to solve the technical problems of the wearable quick-release connection structures in the related art, such as tool-dependent cumbersome operations hindering rapid deployment, repeated adjustments required for tool-free alternatives, or insufficient stability causing accidental detachment risks.

To achieve the above objective, the present disclosure provides a wearable quick-release connection structure for a photography device, including:
a male connector including a plug component and a lanyard connected with the plug component, the plug component being provided with a locking portion, and the lanyard being configured to connect to the photography device; and
a female connector including a bearing seat and a locking assembly, the bearing seat being defined with a receiving cavity, the receiving cavity being featured with an access port configured to receive the plug component, and a wire routing port communicated with the access port and configured for the lanyard to pass through and extend outside of the bearing seat, the plug component being capable of being inserted into the receiving cavity through the access port and advancing toward the wire routing port; the locking assembly being arranged in the bearing seat and at least partially located within the receiving cavity; and the locking assembly including at least one locking component that is capable of moving relative to the bearing seat, and the locking component being provided with a snap-fit portion that is engaged with the locking portion.

In some embodiments, the locking component is provided with a first inclined surface along an axial direction of the access port, and an outer surface of the plug component is in contact with the first inclined surface. The locking assembly further includes at least one first elastic reset component located between a side wall of the receiving cavity and the locking component, and the first elastic reset component is configured to apply a force to the locking component for resetting the locking component.

In some embodiments, the snap-fit portion is a block constructed on the locking component, the locking portion is a slot adapted to the block, and the block is engaged in the slot to allow the plug component to be fixed relative to the bearing seat.

In some embodiments, a side wall of the receiving cavity is defined with a recess configured to receive the locking component; and the first elastic reset component is arranged in the recess.

In some embodiments, the locking component is one of at least two locking components, and the at least two locking components are spaced apart, with each arranged on one of two sides of the receiving cavity.

In some embodiments, a top wall of the receiving cavity near the wire routing port is extended with a first flange, and the first flange is configured to abut against the plug component.

In some embodiments, an axis of the access port is perpendicular to an axis of the wire routing port.

In some embodiments, the wire routing port is U-shaped.

In some embodiments, the plug component is configured as a columnar or flat shape.

In some embodiments, the locking component is located at an end of the receiving cavity; and the locking assembly further includes: at least one second elastic reset component arranged along an axis of the access port and located between the locking component and a cavity wall of the receiving cavity; a limiting component provided at the other end of the receiving cavity, the limiting component being configured to abut against the locking component and support the plug component; and at least one third elastic reset component located between the limiting component and a bottom wall of the bearing seat, the third elastic reset component being configured to apply a force to the limiting component to reset the limiting component.

In some embodiments, one end of the plug component is capable of inserting into the wire routing port, and the wire routing port is provided with a second flange configured to press against the plug component.

In some embodiments, the snap-fit portion is a block constructed at an end of the locking component close to the wire routing port, the locking portion is a slot adapted to the block, and the block is engaged in the slot to allow the plug component to be fixed relative to the bearing seat. The limiting component is defined with a limiting slot, a part of the block is engaged in the engagement groove, and another part of the block is capable of being engaged in the limiting slot.

In some embodiments, the limiting component is provided with a second inclined surface along an axial direction of the wire routing port, and an outer surface of the locking component is in contact with the second inclined surface.

In some embodiments, the female connector further includes a mounting plate connected with the bearing seat, an end of the mounting plate is provided with a guiding block, the locking component is defined with a guiding groove adapted to the guiding block, the locking component is capable of sliding along the guiding block, and the other end of the mounting plate is defined with a mounting cavity configured to receive the limiting component.

According to the present disclosure, the locking assembly of the wearable quick-release connection structure includes at least one locking component that is capable of moving relative to the bearing seat. Through movement of the locking component, the snap-fit portion engages with or disengages from the locking portion of the plug component of the male connector, achieving the locking and unlocking functions of the wearable quick-release connection structure. Compared to the wearable quick-release connection structures that require specialized tools for assembly and disassembly, the wearable quick-release connection structure of the present disclosure achieves the connection between the male connector and the female connector by simply inserting and moving the plug component and no tools required. This allows rapid attachment of the photography device to a wearable device such as a shoulder strap or a wrist strap in urgent shooting scenarios, improving photographic efficiency and preventing the loss of shooting opportunities due to cumbersome operations. Additionally, unlike the tool-free wearable quick-release connection structures that require repeated angle adjustments and precise force control, users only need to follow the operational steps to insert and move the plug component to complete the connection, reducing operational complexity while enhancing user-friendliness. The wearable quick-release connection structure realizes a stable and reliable connection through the engagement between the locking component and the locking portion, effectively reducing the risk of unintentional detachment.

### BRIEF DESCRIPTION OF THE DRAWINGS

FIG. 1 is a schematic structural diagram of a wearable quick-release connection structure according to a first embodiment of the present disclosure.

FIG. 2 shows a schematic structural diagram of a female connector according to a first embodiment of the present disclosure.

FIG. 3 is an exploded schematic diagram of the female connector in FIG. 2.

FIG. 4 is a schematic structural diagram of a wearable quick-release connection structure according to a second embodiment of the present disclosure.

FIG. 5 is a partially exploded schematic diagram of the wearable quick-release connection structure in FIG. 4.

FIG. 6 is a schematic structural diagram of a female connector according to a second embodiment of the present disclosure.

FIG. 7 is a schematic structural diagram of a bearing seat according to a second embodiment of the present disclosure.

Reference numbers are illustrated as follows:

| Label | Name | Label | Name |
|---|---|---|---|
| 100 | wearable quick-release | 10 | male connector |
| | connection structure | | |
| 11 | plug component | 12 | lanyard |
| 111 | locking portion | 20 | female connector |
| 21 | bearing seat | 22 | locking assembly |
| 210 | receiving cavity | 213 | ling-passing port |
| 212 | access port | 222 | snap-fit portion |
| 221 | locking component | 224 | first elastic reset component |
| 223 | first inclined surface | 112 | slot |
| 225 | block | 215 | first flange |
| 214 | recess | 217 | second flange |
| 226 | second elastic reset | 228 | third elastic reset component |
| | component | | |
| 227 | limiting component | 230 | second inclined surface |
| 229 | limiting slot | 231 | guiding block |
| 23 | mounting plate | 233 | mounting cavity |
| 232 | guiding groove | | |

The realization, functional features and advantages of the object of the present disclosure will be further described with reference to the drawings in combination with the embodiments.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely configured to explain relative position relationships or motion conditions between the components in a specific attitude (as shown in the drawings). The directional indication changes as the specific attitude changes.

It should be noted that when an element is described as “being fixed on” or “being arranged on” another element, the element may be directly arranged on the another element or there may be an intermediate element. When an element is described as “being connected to” another element, the element may be directly connected to the another element or there may be an intermediate element.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

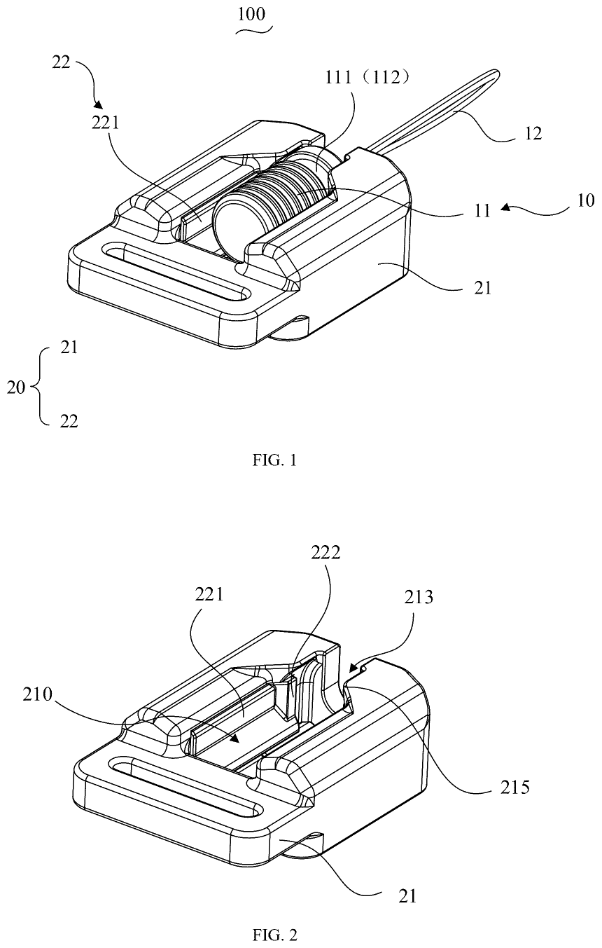

Referring to FIG. 1 to FIG. 3, according to a first embodiment, the present disclosure provides a wearable quick-release connection structure 100 for a photography device. The wearable quick-release connection structure 100 includes a male connector 10 and a female connector 20.

The male connector 10 includes a plug component 11 and a lanyard 12 connected to the plug component 11. The plug component 11 is provided with a locking portion 111, and the lanyard 12 is configured to connect a photography device.

The female connector 20 includes a bearing seat 21 and a locking assembly 22. The bearing seat 21 is defined with a receiving cavity 210. The receiving cavity 210 is constructed with an access port 212 configured to receive the plug component 11 and a wire routing port 213 communicated with the access port 212 and configured to allow the lanyard 12 to pass through and extend outside the bearing seat 21. The plug component 11 is capable of being inserted into the receiving cavity 210 through the access port 212 and advancing toward the wire routing port 213. The locking assembly 22 is arranged in the bearing seat 21 and at least partially located within the receiving cavity 210. The locking assembly 22 includes at least one locking component 221 that is capable of moving relative to the bearing seat 21. The locking component 221 is provided with a snap-fit portion 222 that is engaged with the locking portion 111.

The plug component 11, as a key connecting component, is configured to be inserted into the receiving cavity 210 of the female connector 20. The locking portion 111 of the plug component 11 engages with the locking assembly 22 of the female connector 20 to achieve mating connection between the male connector 10 and the female connector 20.

The lanyard 12 is configured to connect the photography device to the male connector 10, to transfer the weight of the photography device to a wearable device such as a shoulder strap or a wrist strap. Moreover, the lanyard 12 cooperates with the plug component 11 to pass through the wire routing port 213 of the female connector 20, achieving connection between the entire wearable quick-release connection structure 100 and the photography device.

The bearing seat 21 is defined with the receiving cavity 210 for providing an insertion space for the plug component 11. The access port 212 is configured to allow the plug component 11 to enter the receiving cavity 210, and the wire routing port 213 is configured to allow the lanyard 12 to pass through. Moreover, the bearing seat 21 serves as a mounting foundation for the locking assembly 22 to ensure the proper operation of the locking assembly 22.

The locking assembly 22 includes at least one locking component 221 that is capable of moving relative to the bearing seat 21. Through the movement of the locking component 221, the snap-fit portion 222 engages with or disengages from the locking portion 111 of the plug component 11 of the male connector 10, to achieve the locking and unlocking functions of the wearable quick-release connection structure 100, thereby guaranteeing connection stability and detachability.

When connecting the photography device, the plug component 11 of the male connector 10 is inserted into the receiving cavity 210 through the access port 212 of the bearing seat 21 of the female connector 20. Then, the plug component 11 is moved toward the wire routing port 213, and the lanyard 12 passes through the wire routing port 213 and extends outside the bearing seat 21. Since the plug component 11 is provided with the locking portion 111, and at least one locking component 221 of the locking assembly 22 of the female connector 20 is provided with the snap-fit portion 222 that is engaged with the locking portion 111, when the plug component 11 moves to an appropriate position, the snap-fit portion 222 on the locking component 221 engages with the locking portion 111, to achieve a locked connection between the male connector 10 and the female connector 20, thereby fastening the photography device via the wearable device such as a shoulder strap or a wrist strap.

When detaching the photography device, the locking assembly 22 is operated to allow the locking component 221 to move relative to the bearing seat 21, releasing the engagement between the snap-fit portion 222 and the locking portion 111. Then, the plug component 11 is removed through the access port 212 to complete the detachment.

Compared to the wearable quick-release connection structures that require specialized tools for assembly and disassembly, the wearable quick-release connection structure 100 of the present disclosure achieves the connection between the male connector 10 and the female connector 20 by simply inserting and moving the plug component 11 and no tools required. This allows rapid attachment of the photography device to a wearable device such as a shoulder strap or a wrist strap in urgent shooting scenarios, improving photographic efficiency and preventing the loss of shooting opportunities due to cumbersome operations. Additionally, unlike the tool-free wearable quick-release connection structures that require repeated angle adjustments and precise force control, users only need to follow the operational steps to insert and move the plug component 11 to complete the connection, reducing operational complexity while enhancing user-friendliness. The wearable quick-release connection structure 100 realizes a stable and reliable connection through the engagement between the snap-fit portion 222 of the locking component 221 and the locking portion 111, effectively reducing the risk of unintentional detachment.

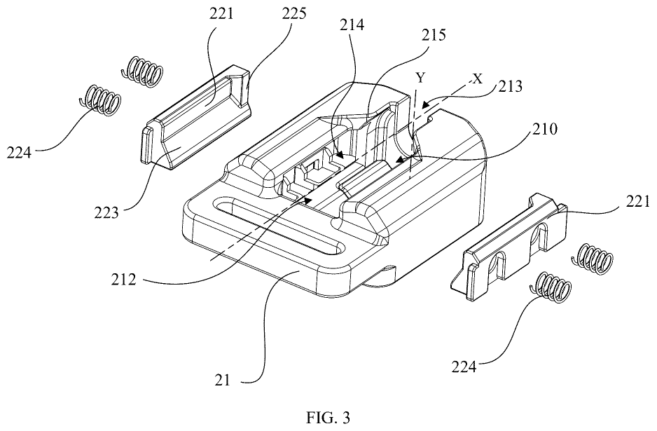

Referring to FIG. 2 and FIG. 3, in some embodiments, the locking component 221 is provided with a first inclined surface 223 along an axial direction of the access port 212, and an outer surface of the plug component 11 is in contact with the first inclined surface 223.

The locking assembly 22 further includes at least one first elastic reset component 224 located between a side wall of the receiving cavity 210 and the locking component 221. The first elastic reset component 224 is configured to apply a force to the locking component 221 for resetting the locking component 221.

In the embodiments, the first inclined surface 223, serving as a force transmitting structure, converts an axial thrust of the plug component 11 into a radial displacing force for the locking component 221. This achieves asymmetric force application through wedge transmission, thereby driving the displacement of the locking component 221.

The first elastic reset component 224 performs dual functions of energy storage and reset. During insertion of the plug component 11, the first elastic reset component 224 absorbs kinetic energy and converts it into elastic potential energy; and when the snap-fit portion 222 aligns with the locking portion 111, the stored energy is released, realizing rapid and precise locking of the snap-fit portion 222.

In some embodiments, the snap-fit portion 222 is a block 225 constructed on the locking component 221, and the locking portion 111 is a slot 112 adapted to the block 225. The block 225 is engaged in the slot 112 to allow the plug component 11 to be fixed relative to the bearing seat 21.

The block 225 and the slot 112 are the key for mechanical locking. Through precise cooperation of the convex and concave structures, a multi-dimensional constraint is constructed to limit the degrees of freedom of the plug component 11 in the axial, radial, and rotational directions, thereby ensuring the connection rigidity.

When the plug component 11 is inserted into the receiving cavity 210 of the female connector 20, the outer surface of the plug component 11 and the first inclined surface 223 of the locking component 221 cooperatively form a wedge-shaped transmission structure. As the plug component 11 advances along the axis X of the access port 212, an oblique component force of the first inclined surface 223 drives the locking component 221 to compress the first elastic reset component 224, allowing the first elastic reset component 224 to move toward the side wall. When the plug component 11 moves to the position where the block 225 aligns with the slot 112, the locking component 221 that is no longer subjected to the directional thrust rapidly returns to its original position by the elastic force of the first elastic reset component 224, so that the block 225 is accurately embedded into the slot 112 and a mechanical locking is achieved. This process utilizes the synchronized linkage of wedge transmission and elastic reset to realize automated self-locking connection upon insertion. During disassembly, a force is applied to push the locking component 221 so as to compress the first elastic reset component 224 again, so that the block 225 is disengaged from the slot 112, releasing the locking.

The wearable quick-release connection structure 100 in the embodiments eliminates manual adjustment, and achieves automatic locking during insertion. This reduces operational error rates, and is particularly suitable for single-handed quick-connection scenarios. Moreover, the first elastic reset component 224 continuously provides preload force to the block 225, which, cooperated with the barbed design of the slot 112, creates a self-locking effect that intensifies under dynamic operating conditions such as vibrations or impacts during photography device operation.

In some embodiments, the side wall of the receiving cavity 210 is defined with a recess 214 for accommodating the locking component 221, and the first elastic reset component 224 is arranged in the recess 214.

The recess 214 in the side wall of the receiving cavity 210 establishes a three-dimensional mechanical constraint space. When the plug component 11 pushes the locking component 221 to move via the first inclined surface 223, the side wall of the recess 214 restrict degrees of freedom of the locking component 221 through normal constraint forces, ensuring that the block 225 translates along a predetermined path. The first elastic reset component 224 forms a sealed elastic energy storage unit within the recess 214, with its compression amount linearly related to its displacement, thereby providing a constant reset driving force to the block 225.

In some embodiments, the locking assembly 22 includes at least two locking components 221. The at least two locking components 221 are spaced apart, with each arranged on one of two sides of the receiving cavity 210.

The locking components 221 located on two sides of the receiving cavity 210 serve as core locking components. The symmetrical arrangement establishes a force-couple constraint that not only distributes the load pressure from the photography device but also mutually counterbalances to prevent rotation or misalignment of the plug component 11 within the receiving cavity 210. Each locking component 221 has an independent block 225 for cooperating with the slot 112, providing dual-lock security.

Moreover, the first elastic reset components 224 on two sides are mutually independent to establish a distributed energy storage. During the locking process, the two first elastic reset components 224 store and release energy simultaneously, ensuring that the two blocks 225 engage into the slot 112 at the same speed and under equal force, thereby maintaining the mechanical balance of the connection structure. If one elastic reset component fails, the other one can still provide basic locking functionality, enhancing the system reliability.

When the plug component 11 is inserted into the receiving cavity 210, the outer surface of the plug component 11 is in contact with the first inclined surfaces 223 of the two locking components 221 to establish a symmetrical wedge transmission mechanism. During insertion, the plug component 11 applies equal and opposite thrust forces to the two locking components 221, driving the two locking components 221 to synchronously compress their respective first elastic reset components 224. When the respective block 225 is aligned with the slot 112, the first elastic reset components 224 release energy to drive the two blocks 225 to simultaneously engage into the slot 112 from both sides, establishing a three-point mechanical locking. This bilateral linkage mechanism leverages force equilibrium principles to ensure uniform stress distribution on the plug component 11 during connection, preventing eccentric wear caused by unilateral force. Thus, the structure achieves a high-precision, high-strength, and stable connection.

In some embodiments, the top wall of the receiving cavity 210 near the wire routing port 213 is extended with a first flange 215, and the first flange 215 is configured to abut against the plug component 11.

The first flange 215 serves as an upper limiting component. It provides a stable upper boundary for limiting the plug component 11 by its fixed connection with the top wall of the receiving cavity 210. When the plug component 11 moves to a predetermined position, the lower surface of the first flange 215 tightly abuts against the top end surface of the plug component 11, to limit the upward movement of the plug component 11. This ensures positional accuracy of the plug component 11 in the vertical direction, establishing a foundation for the accurate engagement between the blocks 225 and the slot 112.

The bottom wall of the receiving cavity 210 serves as a lower limiting part, and establishes a spatial closed-loop for upper and lower constraint cooperatively with the first flange 215. The receiving cavity 210 provides insertion space and horizontal inserting guidance for the plug component 11, and the bottom wall of the receiving cavity 210 together with the first flange 215 allow the position of the plug component 11 in the vertical direction being fixed, ensuring accurate spatial positional relationship among all the components of the wearable quick-release connection structure 100.

During insertion of the plug component 11 into the receiving cavity 210 of the bearing seat 21 and its advancement toward the wire routing port 213, the first flange 215 imposes vertical constraint on the plug component 11 from above. As the plug component 11 advances, the top end face of the plug component 11 comes into contact with the lower surface of the first flange 215. Since the first flange 215 is fixedly connected to the top wall of the receiving cavity 210 near the wire routing port 213, it prevents upward displacement of the plug component 11. Moreover, the bottom wall of the receiving cavity 210 serves as a lower datum, it confines vertical movement of the plug component 11 within a fixed range together with the first flange 215.

The vertical limiting design in the embodiments effectively restricts the wobbling space of the plug component 11 in the vertical direction. When the photography device is subjected to external impacts or vibrations, any vertical displacement is prevented from causing loosening between the locking block 225 and the locking slot 112, which significantly enhances the vibration resistance of the wearable quick-release connection structure 100, reducing the risk of unintentional disengagement.

In some embodiments, the first flange 215 has an arc-shaped structure. The arc-shaped first flange 215 helps prevent scratches or damage to the plug component 11. During insertion, the arc-shaped surface of the first flange 215 can provide a softer contact with the plug component 11, reducing the likelihood of wear, deformation, or scratches caused by rigid contact. This helps protect both the plug component 11 and the first flange 215, extending the service life. Additionally, the arc-shaped structure offers excellent compressive and bending resistance. When the plug component 11 is inserted and abutted against the first flange 215, the arc-shaped structure helps distributing the pressure from the plug component 11 more evenly, minimizing stress concentration. This enhances the structural stability of the connection between the first flange 215 and the top wall of the receiving cavity 210, reducing the risk of cracks or damage due to prolonged stress.

In some embodiments, the axis X of the access port 212 is perpendicular to the axis Y of the line-passing outlet 213.

In some embodiments, the wire routing port 213 is U-shaped.

In some embodiments, the plug component 11 is configured as a columnar or flat shape.

The axis X of the access port 212 is perpendicular to the axis Y of the wire routing port 213, so that after the plug component 11 is inserted into the receiving cavity 210, the lanyard 12 can exit perpendicular to the direction of the plug component 11. This allows the plug component 11 of the male connector 10 to be stably positioned within the receiving cavity 210 while also realizes rational routing of the lanyard 12 without mutual interference. This allows for a well-organized spatial layout of the connection structure, such that all components can work together effectively. When the photography device moves with the photographer, the perpendicular arrangement allows the plug component 11 to remain stable in the receiving cavity 210, and tension from the lanyard 12 will not adversely affect the insertion state of the plug component 11. This maintains a secure connection between the male connector 10 and the female connector 20, thereby reducing the risk of unintentional detachment.

The U-shaped wire routing port 213 facilitates easier threading of the lanyard 12. The U-shaped structure provides sufficient clearance, allowing the lanyard 12 to move and adjust within a certain range, while the U-shaped structure can also prevent the lanyard 12 from accidentally disengaging from the wire routing port 213.

When connecting the photography device to a wearable device such as a shoulder strap or a wrist strap, the U-shaped wire routing port 213 simplifies and speeds up the threading process of the lanyard 12. The lanyard 12 can be easily passed through the wire routing port 213 without complicated operations, enhancing the installation efficiency and making it particularly suitable for rapid attachment of device in time-sensitive shooting scenarios. Moreover, the rounded edge of the U-shaped port prevents the lanyard 12 from being abraded by sharp corners. During using, the lanyard 12 may experience friction, the U-shaped design reduces such frictional damage to the lanyard 12, so as to extend the service life of the lanyard 12, thereby ensuring the reliability of the connection structure.

In some embodiments, the plug component 11 is configured as a columnar shape and has a rotatable characteristic. During the motion of the photography device, the plug component 11 rotates to prevent the lanyard 12 from tangling, ensuring smooth connection. This reduces the risk of operational inconvenience or device damage caused by knots and thus enhancing the user experience. In other embodiments, the plug component 11 may be in other shapes such as a flat shape, which is not limited in the present disclosure.

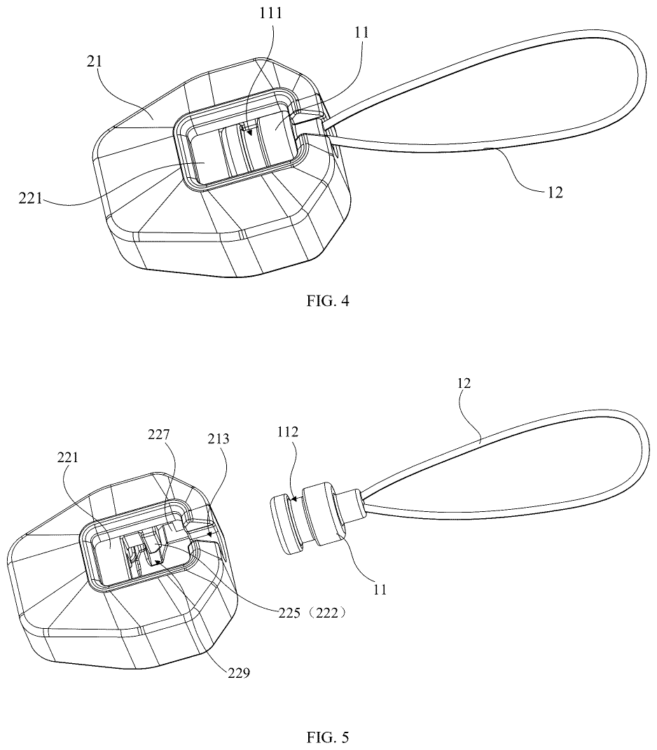

Referring to FIG. 4 to FIG. 7, according to a second embodiment, the locking component 221 is located at an end of the receiving cavity 210. The locking assembly 22 further includes at least one second elastic reset component 226, a limiting component 227, and at least one third elastic reset component 228. The second elastic reset component 226 is arranged along the axis X of the access port 212 and located between the locking component 221 and an outer wall of the receiving cavity 210. The limiting component 227 is arranged at the other end of the receiving cavity 210 and is configured to abut against the locking component 221 and support the plug component 11. The at least one third elastic reset component 228 is located between the limiting component 227 and the bottom wall of the bearing seat 21, and is configured to apply force to the limiting component 227 to reset the limiting component 227.

The second elastic reset component 226 is arranged along the axis X of the access port 212 and located between the locking component 221 and the outer wall of the receiving cavity 210. The second elastic reset component 226 is mainly configured to allow that, in the initial state that the plug component 11 is not inserted, the locking component 221 is pushed away from the wire routing port 213 by the elastic force to provide space for the insertion of the plug component 11. When the plug component 11 is inserted into the receiving cavity 210, the second elastic reset component 226 provides the necessary movement space and preload force for the locking component 221, to facilitate smooth engagement between the locking component 221 and the plug component 11 to complete the connection. Additionally, during disassembly, after the locking component 221 separates from the plug component 11, the second elastic reset component 226 may quickly release its elastic potential energy to drive the locking component 221 to accurately return to its initial position, preparing for the next connection.

The limiting component 227 is located at the other end of the receiving cavity 210 and serves a dual limiting function. On one hand, during insertion of the plug component 11, the limiting component 227 limits the final position of the locking component 221, to prevent excessive advancement of the locking component 221. On the other hand, by abutting against the locking component 221 and providing support to the plug component 11, the limiting component 227, together with the locking component 221 and the third elastic reset component 228, provides a stable mechanical support structure, which ensures precise positioning of the plug component 11 within the receiving cavity 210 and effectively preventing any shake of the plug component 11.

The third elastic reset component 228 is installed between the limiting component 227 and the bottom wall of the bearing seat 21, and is mainly configured to apply a force to the limiting component 227 for resetting the limiting component 227. During the insertion of the plug component 11, the third elastic reset component 228 is compressed by the limiting component 227, storing elastic potential energy. After the plug component 11 is properly seated, the third elastic reset component 228 releases the potential energy to firmly support the limiting component 227 in abutting against the locking component 221, thereby enhancing the stability of the connection structure. During disassembly, the third elastic reset component 228 assists in resetting the limiting component 227, ensuring the cyclic operation of the entire system.

After the plug component 11 is inserted into the receiving cavity 210, the plug component 11 is pushed along the axial direction of the access port 212. The plug component 11 first presses against the locking component 221, driving it to overcome the elastic force of the second elastic reset component 226 and move toward the other end of the receiving cavity 210. As the plug component 11 continues to advance, the locking component 221 pushes the limiting component 227 to compress the third elastic reset component 228 until the plug component 11 reaches the predetermined position. The third elastic reset component 228 releases its elastic potential energy to support the limiting component 227, thereby firmly abutting against the locking component 221. During disassembly, an external force is applied to push the plug component 1111 to move in the opposite direction and compresses the second elastic reset component 226 and the third elastic reset component 228, such that the locking component 221 separates from the plug component 11, and all components return to their initial positions under the action of the elastic forces.

In some embodiments, one end of the plug component 11 may be inserted into the wire routing port 213, and the wire routing port 213 is provided with a second flange 217 for pressing against the plug component 11.

The second flange 217 is located at the wire routing port 213, and is configured to generate a force for pressing against the plug component 11 that is inserted into the wire routing port 213, to limit the movement of the plug component 11. This enhances the connection stability, thereby reducing the shaking and movement of the plug component 11 during use. After the plug component 11 is inserted into the receiving cavity 210 and moves to the appropriate position toward the wire routing port 213, one end of the plug component 11 is inserted into the wire routing port 213. The second flange 217 at the wire routing port 213 applies pressure on the inserted end of the plug component 11 by way of its own structure. This pressure, generated based on the contact and compression between the second flange 217 and the surface of the plug component 11, mechanically secures the plug component 11 in place, so as to limit the displacement of the plug component 11 in the direction perpendicular to the plane of the wire routing port 213, thereby establishing a stable constraint on the plug component 11.

In the embodiments, the combination of the limiting component 227 and the third elastic reset component 228 provides a dual stability assurance for the wearable quick-release connection structure 100. The limiting component 227 abutting against the locking component 221 and providing support to the plug component 11, combined with the elastic action of the third elastic reset component 228, can effectively absorb and disperse external forces such as shaking and pulling generated during the moving of the photography device. This reduces the risk of connection loosening due to external forces, ensuring that the photography device remains secure and stable connection with the shoulder strap even in complex shooting environments.

In some embodiments, the snap-fit portion 222 is a block 225 constructed at an end of the locking component 221 close to the wire routing port 213, and the locking portion 111 is a slot 112 adapted to the block 225. The block 225 is engaged in the slot 112 to allow the plug component 11 to be fixed relative to the bearing seat 21. The limiting component 227 is defined with a limiting slot 229. A part of the block 225 is engaged in the latch groove 112, and another part of the block 225 is capable of being engaged in the limiting slot 229.

The block 225 partially engages in the slot 112 to realize synchronous movement with the plug component 11, and achieves partially engaging in the limiting slot 229 during the motion, establishing dual-position locking. As a result, the male connector 10 and the female connector 20 are securely connected. The position design of the block 225 should ensure precise alignment with both the slot 112 and the limiting slot 229 throughout the insertion of the plug component 11.

The slot 112 is defined in the plug component 11 to provide initial positioning for engagement of the block 225. By way of the cooperation of the slot 112 and the block 225 for producing frictional force and positional constraint, the plug component 11 and the locking component 221 achieves synchronous movement while also simultaneously withstanding tensile loads from the weight of the photography device, ensuring the stability of the longitudinal connection. The limiting slot 229 is defined in the limiting component 227. During the synchronous movement of the plug component 11 and locking component 221, the limiting slot 229 gradually receives partial engagement of the block 225, to enhance the lateral restraint on the block 225. The limiting slot 229 and the slot 112 establish a three-dimensional anti-detachment structure, improving the connection stability.

When the plug component 11 is inserted into the receiving cavity 210 of the female connector 20, the block 225 on the locking component 221 partially engages in the slot 112 of the plug component 11. The mated shapes of the two components generate the frictional force and mechanical restraint, to achieve a synchronous movement between the plug component 11 and the locking component 221. During the synchronous movement toward the wire routing port 213, part of the block 225 gradually engages into the limiting slot 229 of the limiting component 227, which further limits the lateral movement of the block 225. When the plug component 11 reaches its predetermined position, the block 225 forms a tight fit with both the slot 112 and the limiting slot 229. The compressed third elastic reset component 228 applies a continuous abutting force to the locking component 221 via the limiting component 227, ensuring a stable connection. When disassembly, an external force is applied to push the locking component 221, such that the block 225 overcomes the engagement resistance from both the slot 112 and the limiting slot 229, releasing the dual restraint. The third elastic reset component 228 allows the limiting component 227 to reset, and the second elastic reset component 226 allows the locking component 221 to reset, completing the unlocking process.

In the embodiments, the engagement between the block 225 and the slot 112 allows the plug component 11 and the locking component 221 to move synchronously. This simplifies the connection process, prevents misalignment of components, and improves assembly efficiency, meeting the need for rapid installation in urgent shooting scenarios. The lateral engagement between the block 225 and the slot 112, combined with the longitudinal restraint from the limiting slot 229 and the elastic abutment from the third elastic reset component 228, establishes a three-dimensional anti-detachment mechanism. This can effectively prevent the photography device from accidentally falling off in complex environments such as intense motion or shake.

Further, during the process of the block 225 engaging into the limiting slot 229, noticeable tactile feedback and audible sound allow users to intuitively perceive the connection progress and status, effectively reducing the likelihood of mis-operation and optimizing the user experience.

In some embodiments, a second inclined surface 230 is provided on the limiting component 227 along the axial direction of the wire routing port 213, and the outer surface of the locking component 221 is in contact with the second inclined surface 230.

When the plug component 11 of the male connector 10 is inserted into the receiving cavity 210 of the female connector 20 and moves toward the wire routing port 213, the locking component 221 moves along with the plug component 11 due to the engagement between the locking component 221 and the plug component 11. During the movement, the locking component 221 pushes the limiting component 227, to allow the limiting component 227 to move downward against the elastic force of the third elastic reset component 228, compressing the third elastic reset component 228. When the plug component 11 moves to the predetermined position and the block 225 accurately engages into the limiting slot 229, the third elastic reset component 228 utilizes its elastic deformation to generate a restoring force so as to push the limiting component 227 to move upward. During the upward movement of the limiting component 227, it applies a continuous force to the locking component 221, so that the block 225 can be firmly engaged in the limiting slot 229, ensuring the stability of the connection structure. This prevents the block 225 from accidentally coming out of the limiting slot 229, thereby maintaining the reliability of the connection.

In the embodiments, the third elastic reset component 228 pushes the limiting component 227 to maintain the block 225 engaging in the limiting slot 229, effectively preventing the block 225 from disengaging from the limiting slot 229 due to external forces. During the use of the photography device, whether it is slight shaking during normal shooting or accidental pulling, the connection structure remains stable, ensuring that the photography device is securely fastened to the shoulder strap.

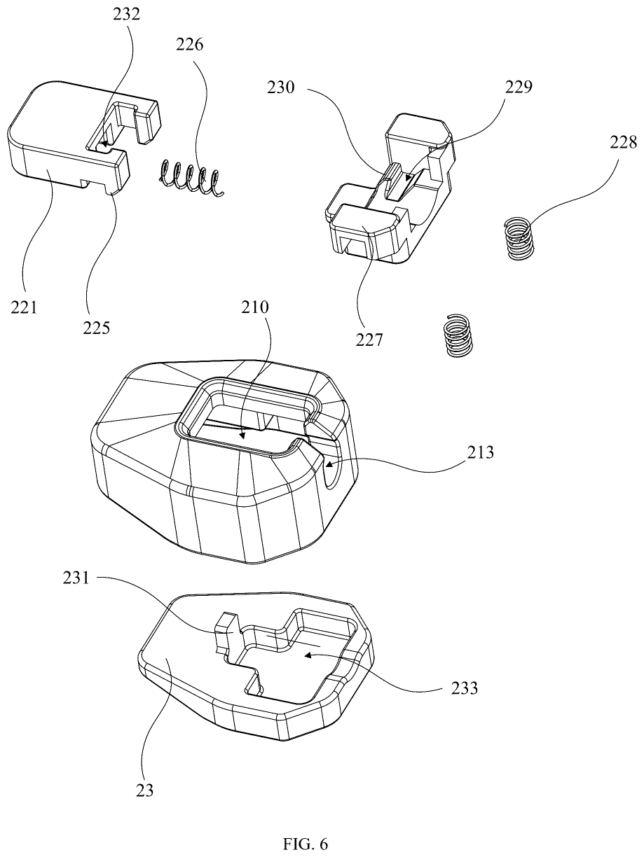

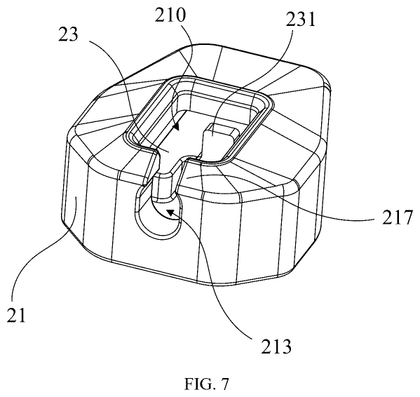

Referring to FIG. 6 and FIG. 7, in some embodiments, the female connector 20 further includes a mounting plate 23 connected with the bearing seat 21. One end of the mounting plate 23 is provided with a guiding block 231, and the locking component 221 is defined with a guiding groove 232 adapted to the guiding block 231. The locking component 221 is capable of sliding along the guiding block 231. The other end of the mounting plate 23 is defined with a mounting cavity 233 for mounting the limit component 227.

The mounting plate 23 serves as a key component connecting the bearing seat 21 with the locking component 221 and the limiting component 227. On one hand, the mounting plate 23 connects the bearing seat 21 with other components to provide structural support as a whole. On the other hand, by providing the guiding block 231 and the mounting cavity 233, the mounting plate 23 provides guidance for the sliding of the locking component 221 and helps fixing the installation of the limiting component 227, ensuring the stability and operability of the connection structure.

The guiding block 231 is mounted at one end of the mounting plate 23, and cooperates with the guiding groove 232 of the locking component 221 to limit the moving direction of the locking component 221. This ensures that the locking component 221 maintains an accurate position during the moving process, realizing reliable engagement with the plug component 11. The mounting cavity 233 is located at the other end of the mounting plate 23, and is configured to receive the limiting component 227 so as to provide a stable mounting position for the limiting component 227. This allows the limiting component 227 to work in coordination with the locking component 221 within the mounting cavity 233, thereby enhancing the locking effect of the connection structure.

When the plug component 11 is inserted into the receiving cavity 210 and pushes the locking component 221 to move, the guiding groove 232 in the locking component 221 slides along the guiding block 231 on the mounting plate 23, ensuring that the locking component 221 moves along a predetermined direction. The limiting component 227 is installed in the mounting cavity 233 of the mounting plate 23. During the movement of the locking component 221, the limiting component 227 and the locking component 221 cooperate with each other to realize the locking of the plug component 11. When disassembled, the limiting component 227 remains stable within the mounting cavity 233 to provide support for the entire connection structure.

In the embodiments, the cooperation between the guiding block 231 and the guiding groove 232 allows the locking component 221 to move along a precise path, which ensures that the block 225 is accurately engaged in the slot 112 of the plug component 11, thereby reducing connection instability caused by misalignment. For example, when quickly connecting the photography device, the locking component 221 can smoothly slide along the guiding block 231 and engages with the plug component 11, improving connection efficiency and reliability. The limiting component 227 being fixed in the mounting cavity 233, combined with the cooperation between the guiding block 231 and the guiding groove 232, ensures stable movement of the locking component 221, allowing the entire connection structure to remain stable even under external forces. Even in a case where the photographing device is accidentally pulled, the limiting component 227 and the locking component 221 can maintain the relative position unchanged under the action of the mounting plate 23, thereby effectively preventing disengagement and enhancing overall structural stability.

The wearable quick-release connection structure 100 according to the first embodiment has the following implementation processes.

### Connecting Process:

The lanyard 12 of the male connector 10 is connected with a photographing device to ensure a firm connected between the photographing device and the male connector 10. Also, it is confirmed that the locking assembly 22 of the female connector 20 is in an initial state, the locking component 221 is in an initial position under the action of the first elastic reset component 224, and the snap-fit portion 222 is in no engagement with any component.

Users may hold the male connector 10 and align the plug component 11 with the access port 212 of the bearing seat 21 of the female connector 20, then steadily insert the plug component 11 into the receiving cavity 210 along the axial direction of the access port 212. The outer surface of the plug component 11 is in contact with the first inclined surface 223 of the locking component 221. As the plug component 11 advances further, the first inclined surface 223 converts the axial thrust of the plug component 11 into the radial moving force of the locking component 221, driving the locking component 221 to compress the first elastic reset component 224 toward the side wall of the receiving cavity 210, thereby creating space for further movement of the plug component 11.

The plug component 11 is further pushed toward the wire routing port 213. When the plug component 11 reaches the predetermined position, the locking portion 111 (the engagement groove 112) of the plug component 11 is aligned with the snap-fit portion 222 (the block 225) of the locking component 221. The locking component 221 that is no longer subjected to the directional thrust rapidly returns to its original position by the elastic force of the first elastic reset component 224, allowing the block 225 to engage into the slot 112 to form a mechanical lock. The first flange 215 located on the top wall of the receiving cavity 210 near the wire routing port 213 tightly abuts against the top end face of the plug component 11 to limit the upward movement of the plug component 11. The bottom wall of the receiving cavity 210 provides support from below to establish an upper and lower limit closed loop with the first flange 215, thereby ensuring that the plug component 11 is fixed in the vertical direction. Consequently, the male connector 10 and the female connector 20 are locked and connected, and the photography device is stably fixed by a wearable device such as a shoulder strap and a wrist strap.

### Disassembly Process:

By manually applying an external force to push the locking component 221, it overcomes the elastic force of the first elastic reset component 224 to move toward the side wall and compress the first elastic reset component 224 again. During this process, the block 225 gradually disengages from the engagement groove 112, releasing the engagement between the locking component 221 and the locking portion 111 of the plug component 11.

After the locking is released, users may hold the male connector 10 and steadily applies a force along the direction opposite to the axis X of the access port 212, to gradually remove the plug component 11 out of the receiving cavity 210 through the access port 212. During the removal process, the lanyard 12 is pulled out through the wire routing port 213 until the male connector 10 and the female connector 20 are completely separated.

After the plug component 11 is removed, the locking component 221 that is no longer subjected to the external force resets by the elastic force of the first elastic reset component 224, preparing for the next connection. The disassembly of the entire wearable quick release connection structure 100 is completed, and the photographing device is separated from the wearable device such as a shoulder strap and a wrist strap.

The wearable quick-release connection structure 100 according to the second embodiment has the following implementation processes.

### Connection Process:

Before the plug component 11 is inserted, the locking component 221 is at its initial position away from the wire routing port 213 by the elastic force of the second elastic reset component 226, to provide space for the insertion of the plug component 11. The limiting component 227 is supported by the third elastic reset component 228 and located at its initial position on the other end of the receiving cavity 210. The guiding block 231 on the mounting plate 23 cooperates with the guiding groove 232 of the locking component 221 to provide guidance for the movement of the locking component 221.

The plug component 11 of the male connector 10 is aligned with the access port 212 of the bearing seat 21 of the female connector 20, and inserted into the receiving cavity 210 along the axial direction of the access port 212. The block 225 on the locking component 221 is partially engaged in the slot 112 of the plug component 11 to realize synchronous movement of the plug component 11 and the locking component 221. The plug component 11 is pushed to drive the locking component 221 to move toward the wire routing port 213, such that the locking component 221 moves toward the other end of the receiving cavity 210 by overcoming the elastic force of the second elastic reset component 226. During this process, the guiding groove 232 in the locking component 221 slides along the guiding block 231 on the mounting plate 23, ensuring the accuracy of the movement path of the locking component 221.

As the plug component 11 advances further, the locking component 221 comes into contact with the second inclined surface 230 on the limiting component 227 and pushes the limiting component 227 to move in a direction perpendicular to the axis Y of the wire routing port 213, such that the limiting component 227 is driven to compress the third elastic reset component 228 located between the limiting component 227 and the bottom wall of the bearing seat 21.

When the plug component 11 moves to a predetermined position, another part of the block 225 is engaged in the limiting slot 229 of the limiting component 227, forming a dual-limiting mechanism. The compressed third elastic reset component 228 releases elastic potential energy, pushing the limiting component 227 to firmly abut against the locking component 221, further enhancing the tightness of the engagement of the block 225 in both the slot 112 and the limiting slot 229. Moreover, one end of the plug component 11 is inserted into the wire routing port 213, and the second flange 217 at the wire routing port 213 presses against the inserted end of the plug component 11 to limit the movement of the plug component 11 in the direction perpendicular to the axis Y of the wire routing port 213, further enhancing the stability of the connection. Consequently, a firm connection between the male connector 10 and the female connector 20 is completed.

### Disassembly Process:

An external force is applied to the plug component 11 in the opposite direction to allow it to move reversely along the axis Y of the wire routing port 213. The reverse movement of the plug component 11 drives the locking component 221 engaged with the plug component 11 to move synchronously, and the locking component 221 begins to overcome the elastic force of the third elastic reset component 228 and the engagement resistance between the block 225 and the slot 112 and the limiting slot 229.

During the reverse movement of the plug component 11 and the locking component 221, the block 225 gradually disengages from the slot 112 and the limiting slot 229, and the third elastic reset component 228 is compressed following the movement of the limiting component 227, storing elastic potential energy.

After the block 225 completely disengages from the slot 112 and the limiting slot 229, the plug component 11 can be smoothly removed through the access port 212. The locking component 221 that is no longer subjected to the external force returns to its initial position under the elastic force of the second elastic reset component 226, and the limiting component 227 also returns to its initial state due to the release of the elastic potential energy from the third elastic reset component 228. All components on the mounting plate 23 reset and prepare for the next connection, completing the entire disassembly process.

The above-mentioned are only part or preferred embodiments of the present disclosure, and neither the words nor the drawings can limit the scope of protection of the present disclosure. Any equivalent structural transformation made by using the specification and drawings of the present disclosure under the concept of the present disclosure as a whole, or directly/indirectly applied in other related technical fields are included in the scope of protection of the present disclosure.

What is claimed is:

1. A wearable quick-release connection structure for a photography device, comprising:
a male connector comprising a plug component and a lanyard connected with the plug component, the plug component being provided with a locking portion, and the lanyard being configured to connect to the photography device; and
a female connector comprising a bearing seat and a locking assembly, the bearing seat being defined with a receiving cavity, the receiving cavity being featured with an access port configured to receive the plug component, and a wire routing port communicated with the access port and configured for the lanyard to pass through and extend outside of the bearing seat, the plug component being capable of being inserted into the receiving cavity through the access port and advancing toward the wire routing port; the locking assembly being arranged in the bearing seat and at least partially located within the receiving cavity; and the locking assembly comprising at least one locking component that is capable of moving relative to the bearing seat, and the locking component being provided with a snap-fit portion that is engaged with the locking portion.

2. The wearable quick-release connection structure according to claim 1, wherein
the locking component is provided with a first inclined surface along an axial direction of the access port, and an outer surface of the plug component is in contact with the first inclined surface; and
the locking assembly further comprises at least one first elastic reset component located between a side wall of the receiving cavity and the locking component, and the first elastic reset component is configured to apply a force to the locking component for resetting the locking component.

3. The wearable quick-release connection structure according to claim 1, wherein
the snap-fit portion is a block constructed on the locking component, the locking portion is a slot adapted to the block, and the block is engaged in the slot to allow the plug component to be fixed relative to the bearing seat.

4. The wearable quick-release connection structure according to claim 2, wherein
a side wall of the receiving cavity is defined with a recess configured to receive the locking component; and
the first elastic reset component is arranged in the recess.

5. The wearable quick-release connection structure according to claim 1, wherein
the locking component is one of at least two locking components, and the at least two locking components are spaced apart, with each arranged on one of two sides of the receiving cavity.

6. The wearable quick-release connection structure according to claim 1, wherein
a top wall of the receiving cavity near the wire routing port is extended with a first flange, and the first flange is configured to abut against the plug component.

7. The wearable quick-release connection structure according to claim 1, wherein
an axis of the access port is perpendicular to an axis of the wire routing port;
and/or,
the wire routing port is U-shaped;
and/or,
the plug component is configured as a columnar or flat shape.

8. The wearable quick-release connection structure according to claim 1, wherein
the locking component is located at an end of the receiving cavity; and
the locking assembly further comprises:
at least one second elastic reset component arranged along an axis of the access port and located between the locking component and an outer wall of the receiving cavity;
a limiting component provided at the other end of the receiving cavity, the limiting component being configured to abut against the locking component and support the plug component; and
at least one third elastic reset component located between the limiting component and a bottom wall of the bearing seat, the third elastic reset component being configured to apply a force to the limiting component to reset the limiting component.

9. The wearable quick-release connection structure according to claim 8, wherein
one end of the plug component is capable of inserting into the wire routing port, and the wire routing port is provided with a second flange configured to press against the plug component.

10. The wearable quick-release connection structure according to claim 8, wherein
the snap-fit portion is a block constructed at an end of the locking component close to the wire routing port, the locking portion is a slot adapted to the block, and the block is engaged in the slot to allow the plug component to be fixed relative to the bearing seat; and
the limiting component is defined with a limiting slot, a part of the block is engaged in the engagement groove, and another part of the block is capable of being engaged in the limiting slot.

11. The wearable quick-release connection structure according to claim 8, wherein
the limiting component is provided with a second inclined surface along an axial direction of the wire routing port, and an outer surface of the locking component is in contact with the second inclined surface.

12. The wearable quick-release connection structure according to claim 8, wherein
the female connector further comprises a mounting plate connected with the bearing seat, an end of the mounting plate is provided with a guiding block, the locking component is defined with a guiding groove adapted to the guiding block, the locking component is capable of sliding along the guiding block, and the other end of the mounting plate is defined with a mounting cavity configured to receive the limiting component.
